(19) United States
(12) Patent Application Publication
(10) Pub. No.: US 2002/0165797 A1
(43) Pub. Date: Nov. 7, 2002

(54) Interactive marketing system

(76) Inventor: Mark C. Deitrickson, Kansas City, MO (US)

Correspondence Address: James E. Brunton Esquire, Suite 860, 700 N. Brand Blvd., Post Office Box 29000, Glendale, CA, 91203, US

(21) Appl. No.: 10/139,066

(22) Filed: May 3, 2002

Related U.S. Application Data
(60) Provisional application No. 60/289,082, filed on May 7, 2001.

(51) Int. Cl. G06F 17/60

(52) U.S. Cl. 705/26

(57) ABSTRACT

An advertising and marketing system which uses micro CD/DVD/DVDA that can be sold and distributed separately. The content available on the micro CD/DVD/DVDA includes music video(s), links to web sites, e-communications and numerous downloads. The micro CD/DVD/DVDA are programmed to deliver a desktop icon to the user's desktop for easy access to the destination programmed into the icon. The foregoing items work in concert with one another to create demand, make available the music video on a wide scale, create a database, and via the desktop icon create a permanent presence on the user's desktop.

### BACKGROUND OF THE INVENTION

This is a Non-Provisional Application based on Provisional Application Serial Number 60/289,082 filed May 7, 2001.

1. Field of the Invention

This invention relates generally to interactive marketing systems. More particularly, the invention concerns a novel marketing and advertising method using a computer readable device comprising a compact disc of the size smaller than a conventional 4.75 inch compact disc and a computer with access to information resources via the Internet.

2. Discussion of the Prior Art

Music compact discs (CDs) and digital videodiscs, (DVDs) and the jewel case or box in which they are marketed have become commonplace, and they are the primary way that music is sold today. In addition, music videos have become a very popular form of entertainment. However, music videos are not widely distributed. Instead, music consumers are for the most part relegated to watching music videos on television and/or the Internet. There is currently no way for consumers to watch those music videos on demand unless they purchase a regular size DVD and/or videotape.

Micro CD/DVD and micro DVD with audio (DVDA) or other enhanced CD/DVD/DVDA products are being used for marketing purposes as handouts to replace “hard copy.” They are used for marketing purposes, and they have videos, animated and other visual media used on them already.

Use of a CD/DVD or other enhanced CD/DVD product to automatically install an icon on a computer is prior art. An icon that allows people to automatically go to a predetermined web site or sites is prior art on a regular size CD/DVD.

### SUMMARY OF THE INVENTION

The product of the present invention is a multimedia combination of a music video and today's equivalent of the old 45 rpm singles of the past. The multimedia and programming features available to the micro CD/DVD/DVDA create endless possibilities never offered with music before.

The micro CD/DVD/DVDA can be used to play music and video and can be programmed to link to other Internet sites when played on a computer CD/ROM with Internet access.

The micro CD/DVD/DVDA of the present invention allows the user/consumer to do any one of, or a combination of, the following:

Link to: Artist site.

Play music videos.

Link to any web site.

Link to: Record Label(s) site.

Place an icon on consumers' desktops to access different URL's (“Uniform Resource Locator”). This icon will remain on the desktop independent of the CD/DVD/DVDA.

Print lyrics or link to site to print lyrics.

Print photographs or link to site to print pictures.

Artist interview(s) and/or introduction of video.

Obtain concert schedules.

Locate ticket outlets and/or provide links to them.

Purchase tickets for concerts.

Purchase CD/DVD/DVDA products directly from web sites.

Enter contests.

Participate in giveaways.

Purchase souvenirs and/or merchandise directly from web sites.

This would be of great value to the music industry because it would allow them to:

Sell music and CD/DVD/DVDA products directly to the public, thus increasing sales.

Sell music and CD/DVD/DVDA products directly to the public, thus increasing profit margin by not having to sell through a “middle man”, intermediaries and/or other retailers.

Advertise and sell merchandise directly to the public, such as shirts, hats, etc., and to advertise to that segment of the public who would be most interested in such products and, thus, would be most likely to purchase said products.

Increase interest in the artist and/or introduce artists to consumers.

Create a “trading card” type of market for the micro CD/DVD/DVDAs.

Allow the music industry to create a database(s) regarding sales information for their products, as well as developing customer lists and addresses for other marketing and sales purposes.

The micro CD/DVD/DVDA or other enhanced CD/DVD/DVDA product of the present invention can be inserted into the music CD/DVD/DVDA purchaser's personal computer, and/or DVD (and/or other device that enables a consumer to play games), attached to a television.

The micro CD/DVD/DVDA or other enhanced CD/DVD/DVDA product has other capabilities as well. For example, an important feature of the method of the present invention comprises the step of loading the micro CD/DVD/DVDA of the invention into a computer to allow the computer user to download an icon onto the computer that permits the user to go directly to record company and/or artists' and/or any web sites. This programming feature and the icon can lead to any designated URL.

At this web site the record company, and/or artist, and/or any web site, could market to those consumer's who are most likely to purchase other CDs/DVDs/DVD. As or other enhanced CD/DVD/DVDA product, from the same or other artists, purchase souvenirs such as T-shirts, hats, mugs, pictures, etc. It would also allow a consumer to download the actual lyrics for the music from the CD/DVD/DVDA or other enhanced CD/DVD/DVDA product.

It would allow information regarding upcoming concerts to be automatically sent by e-mail to a consumer or customer's computer, if they were to request concert information from the micro CD/DVD/DVDA or other enhanced CD/DVD/DVDA product.

It could also allow a consumer to go directly to a web site to purchase tickets for concerts. By utilizing this method more people who would be interested in attending a concert for a particular artist(s) would be made aware of upcoming concerts, and it would increase sales for concerts.

This could also create a “trading card” type of mentality for these micro CD/DVD/DVDA or other enhanced CD/DVD/DVDA products. For example, consumers may begin swapping and trading the micro CD/DVD/DVDA or other enhanced CD/DVD/DVDA products. It could also result in the sale of these micro CD/DVD/DVDA or other enhanced CD/DVD/DVDA products as “music video and/or audio”, similar to the sale of “45 rpm” records in the past.

Each micro CD/DVD/DVDA or other enhanced CD/DVD/DVDA product is custom silk screened or labeled to depict art as desired, so that it will mesh with or complement the merchandising insert and/or regular size CD/DVD/DVDA or other enhanced CD/DVD/DVDA products or other artwork. The imaging process will authenticate the micro CD/DVD/DVDA or other enhanced CD/DVD/DVDA products will authenticate the micro CD/DVD/DVDA or other enhanced CD/DVD/DVDA product as an original collector's piece.

As previously mentioned, the method of the invention that enables the computer user to put an icon on the desktop of the computer using a micro CD/DVD/DVDA or other enhanced micro CD/DVD/DVDA of the invention is believed novel. Further it is believed that having a way to link to a separate URL(s) and/or web sites from a micro CD is not known to be prior art and is believed to be unique. The desktop icon will be delivered with the user's permission to the user's desktop of the computer system. The desktop icon will provide instant access to the destination of its intended use as programmed for use on the micro CD/DVD/DVDA.

In addition, the idea of using the micro CD/DVD/DVDA or other enhanced CD/DVD/DVDA product(s) to create a customer database for the music industry is a new concept, in that; the purchased merchandise (the micro CD/DVD/DVDA product) is the delivery vehicle for the icon.

Similarly, putting a “cookie” on a computer is also prior art. However, the concept of a micro CD/DVD/DVDA or other enhanced CD/DVD/DVDA product enabling a customer and/or consumer to request to be advised when a certain artist and/or group is going to have a concert, and then having that customer and/or consumer notified by e-mail when a concert has been scheduled, is innovative, especially as applied to this overall system.

The idea of having a link to a web site from a micro CD/DVD/DVDA or other enhanced CD/DVD/DVDA product, to allow for the purchase of CD/DVD/DVDA or other enhanced CD/DVD/DVDA products and other merchandise directly from the music industry (or any other industry) is also innovative. This will allow for the direct purchasing of products, and that will allow for a higher profit margin for the music (or other) industry, in that, they will not have to share the profits with retailers or other “middlemen”, or a reduced number of retailers and/or middlemen.

By way of summary, any one of, or any combination of, the following options can be utilized on the micro CD/DVD/DVDA of the invention:

Micro CD/DVD/DVDA could contain additional songs.

Micro CD/DVD/DVDA could contain music video(s).

Micro CD/DVD/DVDA could have any one of, or all of, the following functions:

Link to: Artist site

Link to: Record Label(s) site

Link to any web site(s)

Sell music or other e-commerce

Sell merchandise: shirts, hats, etc.

Download an icon on consumers' desktops to access different URL's.

Print lyrics or link to site to print lyrics

Print photographs or link to site to print pictures

Artist introduces video

Artist interviews

Concert schedules

Ticket outlets

Enter contests

Participate in giveaways

The Micro CD/DVD/DVDA Marketing system described herein will drive retail sales; greatly enhance on-line sales and/or e-commerce while creating a serious enthusiasm and excitement among music buyers that will drive a new era of sales.

It is believed that the inventive marketing system will do the following:

1) Increase sales at the retail level.

2) Create secondary sales by linking them to Internet e-commerce sites.

3) Increase peer customer sales (e.g., consumer sharing them with friends).

4) Create a new excitement in the music industry's consumers.

5) Create a customer database.

6) Plug this new database (derived from the downloadable icon) into buying on the Internet

7) Continue to solicit consumers, virtually cost free, through the e-mail database compiled.

8) Allow the music industry to bring commercials and specials to this new database for almost no cost.

9) Create a collectable frenzy among music consumers.

10) Create a new income stream from older music and artists, because the micro CD/DVD/DVDA will further enhance already popular classic and/or vintage music.

11) Create a positive industry shift that will cause the music industry's customer base to share songs, lyrics, mailing and creating posters of lyrics giving them to their girlfriends, wives, friends, etc.

12) Recoup music video costs, in that, this is a new way to merchandise, and/or derive income from, music videos, thus serving to assist in recouping music video costs.

13) Give music consumers something they haven't had before, in that, the micro CD/DVD/DVDA will allow for widespread access to music videos, which were not previously available for “on demand” viewing except on full size DVDs.

The invention performs these functions:

1) The micro CD/DVD/DVDA will add a new and exciting element to music and video ability. The micro CD/DVD/DVDA creates a unique desire to possess it. The music consumer market has not been widely exposed to the micro CD/DVD/DVDA. Consumers will want to share the micro CD/DVD/DVDA with friends and co-workers. It will add a collectable feature to the market. The size of the micro CD/DVD will allow it to be carried in a pocket or wallet.

2) The micro CD/DVD/DVDA will include a series of inter-active buttons. Inter-active button(s), afforded through the micro CD/DVD/DVDA, will offer additional music CDs/DVDs/DVDAs, which may be purchased from the artist via a web site link from the CD/DVD/DVDA they just purchased.

This will provide consumers with an option to go on-line to purchase more music by the simple touch of a button on the micro CD/DVD/DVDA, getting them in the habit of purchasing music on-line from the label(s) or artist site and/or any music site.

Music lovers will share and pass the micro CD/DVD/DVDA around, which will expose other buyers to this artist and immediate access to purchase.

3) We believe this packaging/marketing change will create a new excitement and create a buying phenomenon.

4) For the first time the music industry will be able to create a customer database from retail CD/DVD/DVDA sales.

5) From these new databases there will be many ways to use this information. Customers will be able to buy on-line, direct from the artist/label/music site. This invention will make it effortless to buy music right from the CD/DVD/DVDA (through the link to the web site(s). This will help to transition music buyers into buying online to complement their retail purchases. This should cause music consumers to increase their music purchases. By making it easier for consumers to buy music online, and exposing them to more music, it will increase consumer desire for music, translating into more sales.

6) The downloadable icon from the micro CD/DVD/DVDA will give artists and labels more exposure by placing a record label/artist/music site icon on the desktop. This is a very valuable marketing tool and customer access. These inventions can shape consumer habits and really plug the consumer into the label/artist (we do this utilizing the new database created from the downloadable icon on the micro CD/DVD/DVDA).

7) Record labels will also be able to bring commercials and special offers right to the consumer database via the desktop icon.

8) The very nature of this packaging/marketing program we believe will create increased sales. As a collectable it will increase sales even more.

9) This marketing system and these inventions will also create a new income stream by creating new interest in repackaged older music. For example, most people that are Beatles fans probably have never been to a Beatles concert. If you offer a micro CD/DVD/DVDA from one of the Beatles CD/DVD/DVDA's with a 5 minute clip from a Beatles concert people will want to have it/add it to their new “COLLECTION” of collectable Beatles micro video CD/DVD/DVDA's.

The Micro CD/DVD/DVDA marketing system consists of a packaging change that ties into an innovative marketing plan. It could include a micro CD/DVD/DVDA packaged for individual sale.

### BRIEF DESCRIPTION OF THE DRAWINGS

FIG. 1 is a generally perspective, diagrammatic view showing one form of micro CD/DVD or DVDA being loaded into a CD/ROM drive of a computer.

FIG. 2 is a generally perspective view showing one form of a micro CD/DVD of the invention in a jewel case for a micro CD, and also showing a conventional size CD/DVD in a larger jewel case.

### DESCRIPTION OF THE INVENTION AND STRATEGY

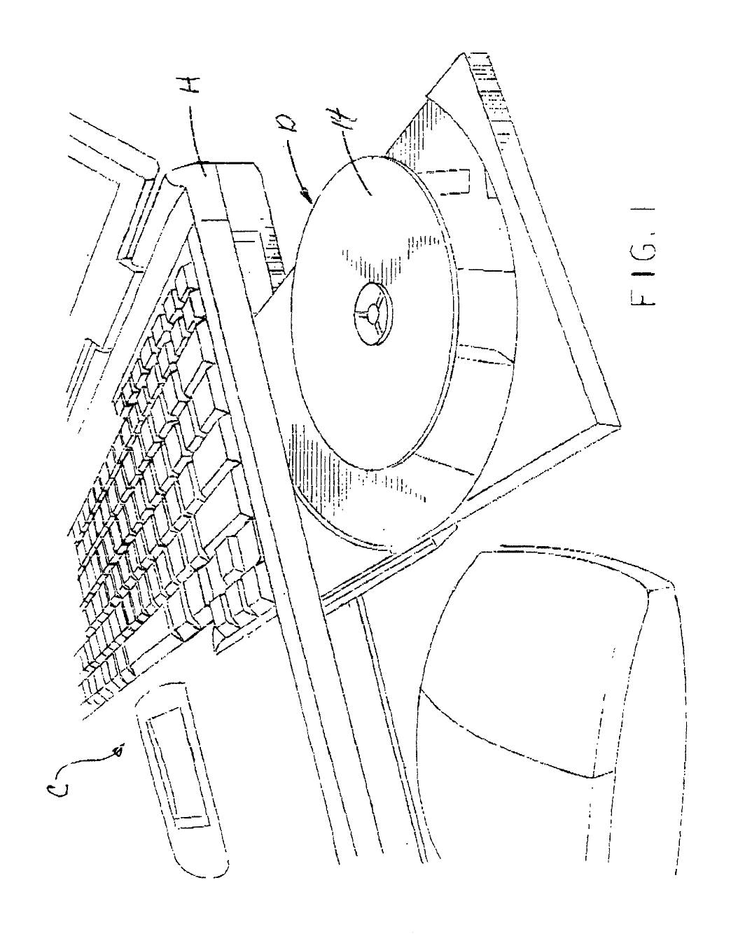

Referring to the drawings and particularly in FIG. 1, the first step in and one form of the method of the invention is there illustrated, namely the loading of one form of the compact disk of the invention into a conventional computer “C” having access to information resources via the Internet. As shown in FIG. 1, computer “C” includes a housing “H” having a CD drive “D” that is configured to accept a conventional 4.75 inch CD.

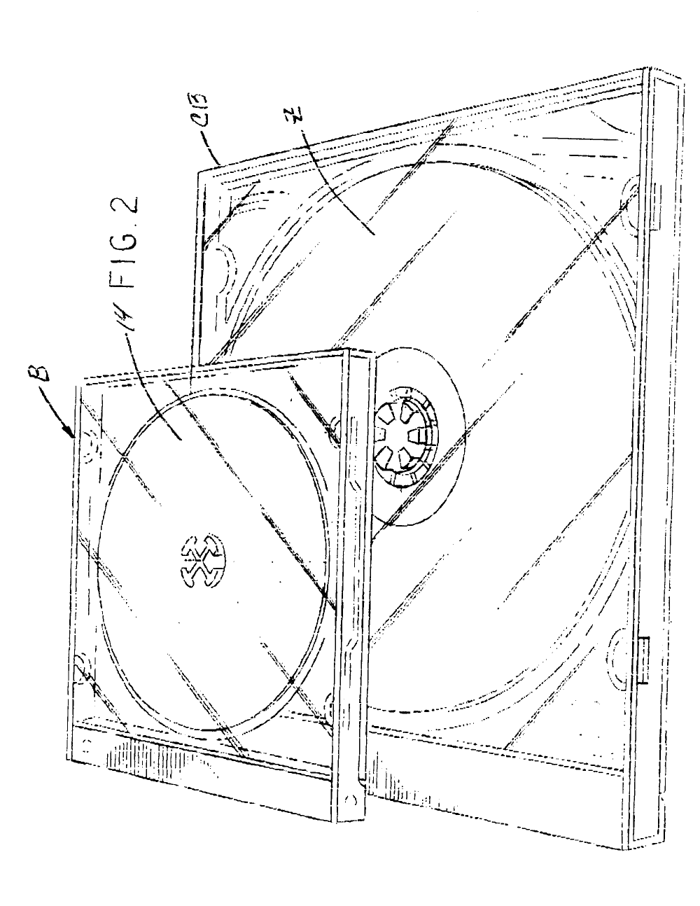

Turning to FIG. 2, one form of the compact disk, or computer readable device 14 of the invention is shown contained within a specially designed jewel box “B”. As indicated in FIG. 2, compact disk 14 is of a size less than the conventional 4.75 inch CD “Z” that is shown mounted within a conventional jewel box “CB”. While CD 14 can be of various sizes, it is preferably approximately 3 inches in diameter.

As earlier discussed, in accordance with the method of the invention, loading the computer readable device into the computer selectively provides a link to an Internet site and functions to automatically install an icon on the desktop of the computer to enable the computer user to access a plurality of Uniform Resource Locators.

Novel features of the present invention include the following:

1. The music industry's best marketing tool, the music video has not been available to the public in this format.

2. Enthusiasm and demand for this new micro CD/DVD/DVDA will increase demand for music videos.

3. The micro CD/DVD/DVDA will create demand as a collectable. Each multimedia CD/DVD/DVDA can be custom silk-screened and/or labeled, and can retain its identity as a legal collectable.

4. Because of the unique size of a micro CD/DVD/DVDA, it can be passed around easily. More exposure translates to more music sales. Music lovers will pass the micro CD/DVD/DVDA around; each time it is viewed it is an advertisement for the artist.

5. The sale of individual micro CD/DVD/DVDAs will allow consumers to pick the music videos that they want to buy, instead of having to purchase an entire CD with many songs that they may not want to purchase.

6. The micro CD/DVD/DVDAs will be an ideal promotional item for certain companies.

Each micro CD/DVD/DVDA will have one or more of the following including a Navigational GUI that upon loading it into the computer will allow the consumer to:

A) Link to the artist/label store. The micro CD/DVD/DVDA will lead customers to the order desk because the micro CD/DVD/DVDA is played on the computer. This link sets up a secondary sales environment to offer additional music and products related to this particular artist.

B) Download the lyrics. Download the lyrics from the artist onto colorful 8 ½″×11″ prints that can be shared with friends and also emailed. This produce will create a positive industry shift that will have the customer base sharing lyrics to songs, reading, mailing and creating posters of verses and songs to give to girlfriends, wives, etc.

C) Download an Icon onto the computer desktop. This invention will give artists and labels more exposure by placing a record label icon on the desktop. We consider this extremely valuable access for marketing purposes. This is where consumer habits can be shaped and it can really plug the consumer into the label. Building a database from on line inquiries and capturing contact information will accomplish this. Special offers and promotions are good reasons to contact active consumers.

D) Artist talks. The artist will have an opportunity to address the fans and introduce the music video on the inter-active CD/DVD/DVDA.

E) Pictures. Fans can print pictures of their favorite artist up to 8 ½″×11″. On photo quality paper and today's printers these will be real fan collectables.

F) Add value to classic music. This program will also create a new revenue stream by repackaging older music with this system. For example, most people that are Beatles fans probably have never been to a Beatles concert. If you could add a micro CD/DVD/DVDA to one of the classic CD's with a 5-minute clip from a concert, fans will want to have it to add to their collection.

The music industry already has thousands of music video's that have not been readily available. Once they become available on the multi-media micro CD/DVD/DVDA format they will revitalize demand of older and still popular music CD's.

The multi media micro CD/DVD/DVDA will be used to market the most popular music videos from the past. These inventions will allow the music industry to convert these videos from the past into a new revenue source. These classic videos may be offered when the videos are viewed on television or as an offering on the artist's web site.

In summary, this marketing system will revolutionize what is arguably already the most successful and universal industry on this planet. The ability to link the popularity of music videos to the music in an easily obtainable format will be wildly popular. The link to web sites to facilitate additional sales will be phenomenal. The novelty and collectable effect in this day of collectibles and e-bay is virtually immeasurable. The value of the desktop icon as a marketing tool is inestimable.

It is to be understood that the micro CD/DVD/DVDA of the invention can have different shapes and are not limited to being round or circular. For example the micro compact disks can be oblong, square, rink shaped, star shaped, or any other desired shape. Preferably, the compact disks of the invention are circular in shape and are approximately 3 inches in diameter.

I claim:

1. A marketing method using a computer readable device comprising a compact disk of the size smaller than a conventional 4.75 inch compact disk and a computer with access to information resources via the Internet comprising the step of loading the computer readable device into the computer to provide a link to an Internet site.

2. The marketing method as defined in claim 1 in which the compact disc includes recorded music and in which the Internet site is an artist site.

3. The marketing method as defined in claim 1 in which the compact disk comprises a digital video disk.

4. The marketing method as defined in claim 1 in which the compact disk comprises a digital video disk with audio.

5. The marketing method as defined in claim 1 in which the compact disc includes recorded music and in which the Internet site is a record label site.

6. The marketing method as defined in claim 1 and which said computer readable device enables transfer to the computer of information in response to a download request by the computer user.

7. The marketing method as defined in claim 1 comprising the step of loading the computer readable device into the computer to provide a link to an Internet site that will enable the computer user to purchase merchandise over the Internet.

8. The marketing method as defined in claim 1 comprising the step of loading the computer readable device into the computer to provide a link to an Internet site that will enable a computer user to conduct interviews with third parties.

9. An advertising and merchandising method using a computer readable device comprising a compact disk of the size smaller than a conventional 4.75 inch compact disk and a computer having a desktop and access to information resources via the Internet comprising the step of loading the computer readable device into the computer to automatically install an icon on the desktop of the computer to enable the computer user to access a plurality of Uniform Resource Locators.

10. The advertising and merchandising method as defined in claim 9 in which the compact disk comprises a digital video disk.

11. The advertising and merchandising method as defined in claim 9 in which the compact disk comprises a digital video disk with audio.

12. A marketing method using a computer readable device comprising a compact disk of the size smaller than a conventional 4.75 inch compact disk and a computer with access to information resources via the Internet comprising the steps of:
(a) loading the computer readable device into the computer to provide a link to an Internet site; and
(b) loading the computer readable device into the computer to automatically install an icon on the desktop of the computer to enable the computer user to access a plurality of Uniform Resource Locators.

13. The marketing method as defined in claim 12 in which the compact disc includes recorded music and in which the Internet site is an artist site.

14. The marketing method as defined in claim 12 in which the compact disk comprises a digital video disk.

15. The marketing method as defined in claim 12 in which the compact disk comprises a digital video disk with audio.

16. The marketing method as defined in claim 12 in which the compact disc includes recorded music and in which the Internet site is a record label site.

17. The marketing method as defined in claim 12 in which the compact desk includes a video recording.

18. The marketing method as defined in claim 12 comprising the step of loading the computer readable device into the computer to provide a link to an Internet site that will enable the computer user to purchase merchandise over the Internet.

19. The marketing method as defined in claim 12 comprising the step of loading the computer readable device into the computer to provide a link to an Internet site that will enable the computer user to conduct interviews with third parties.

20. The marketing method as defined in claim 12 comprising the step of loading the computer readable device into the computer to provide a link to an Internet site that will enable the computer user to download selected information from the Internet site.
